(19) United States
(12) Patent Application Publication
(10) Pub. No.: US 2001/0008580 A1
(43) Pub. Date: Jul. 19, 2001

(54) Multipoint focus detecting apparatus

(75) Inventor: Takayuki Sensui, Tokyo (JP)

Correspondence Address: GREENBLUM & BERNSTEIN, 1941 ROLAND CLARKE PLACE, RESTON, VA, 20191

(73) Assignee: ASAHI KOGAKU KOGYO KABUSHIKI KAISHA, Tokyo (JP)

(21) Appl. No.: 09/760,831

(22) Filed: Jan. 17, 2001

(30) Foreign Application Priority Data
Jan. 18, 2000 (JP) 2000-8770 (P)

(51) Int. Cl. G03B 13/36

(52) U.S. Cl. 396/114; 396/121

(57) ABSTRACT

A multipoint focus detecting apparatus of a camera includes a plurality of exit-pupil dividing devices; a plurality of pairs of light distribution forming devices; a plurality of arrays of light receiving elements, light receiving surfaces thereof being provided on a common plane; a focus detection zone determining device which includes a plurality of focus detection apertures and is positioned in a plane located substantially at a position optically equivalent with a focal plane of the camera photographing lens; and at least one deflecting device which deflects light bundles which are respectively passed through corresponding focus detection apertures, at least one corresponding exit-pupil dividing device, and corresponding pairs of light distribution forming devices so that a principal ray of each of light bundle is incident on a corresponding array of light receiving elements in a direction normal to a light receiving surface thereof.

### BACKGROUND OF THE INVENTION

1. Field of the Invention

The present invention relates to a multipoint focus detecting apparatus which can determine a focus state at each of a plurality of focus detection zones, and which is suitable for an optical instrument such as an SLR camera.

2. Description of the Prior Art

In a known type of focus detecting apparatus, an exit pupil of a photographing lens is divided into two by a focus detection optical system, two object images which are formed by two object light bundles that are passed through the two areas of the divided exit pupils are formed on a pair of arrays of light receiving elements (e.g., a pair of CCD line sensors) to detect a focus state of the photographing lens in accordance with the output of each of the pair of arrays of light receiving elements, and the focusing lens group provided in the photographing lens is driven in accordance with the result of the detection of the focus state to bring the object into focus.

In recent years, SLR cameras provided with a multipoint focus detecting unit for determining a focus state (defocus) at each of a plurality of focus detection zones (focusing points) have been developed. In the optical system of a conventional multipoint focus detecting unit, in addition to the central focus detection zone arranged over the optical axis, one or more off-center focus detection zones are arranged away from the optical axis, and light bundles from an object to be photographed which are passed through the central and off-center focus detection zones are respectively deflected by corresponding mirrors to be incident on corresponding light receiving elements arranged in a horizontal line.

FIG. 10 shows fundamental elements of another conventional multipoint AF sensor unit. In this multipoint AF sensor unit, light bundles La and Lb, which are passed through apertures 301a and 301b formed on a field mask 301 positioned in a plane located at a position optically equivalent with a film surface (i.e., a focal plane of the photographing lens), are converged and deflected by the condenser lenses 302a and 302b in directions to approach each other to pass through separator masks 304a and 304b, respectively. A pair of openings (only one is shown in FIG. 10) serving as an exit-pupil dividing device which determines detection sub-zones are formed on each of the separator masks 304a and 304b. The light bundle La which is passed through the separator mask 304a and a pair of separator lenses 305a (only one is shown in FIG. 10) is incident on a corresponding line sensor 306a, so that a pair of object images (a pair of light distributions) are formed on the line sensor 306a. Likewise, the light bundle Lb which is passed through the separator mask 304b and a pair of separator lenses 305b (only one is shown in FIG. 10) is incident on a corresponding line sensor 306a, so that a pair of object images (a pair of light distributions) are formed on the line sensor 306b. In this conventional multipoint AF sensor unit, at least one of the principal rays of the light bundles La and Lb which are respectively incident on the two pairs of line sensors 306a and 306b does not extend in a direction normal to the light receiving surface of the corresponding line sensor 306a or 306b.

As can be understood from the above discussions, in either conventional multipoint AF sensor unit shown in FIG. 12, at least one of the principal rays of the light bundles La and Lb which are respectively incident on the two pairs of line sensors (305a and 306b) is not normal to the light receiving surface of the corresponding line sensor, while the principal rays of the same light bundles La and Lb are not parallel to each other. Therefore, as in the case of the conventional multipoint AF sensor unit, if a mechanical error occurs and/or each or both of the pair of line sensors deviate from their original positions in the direction normal to the light receiving surfaces of the line sensors (i.e., in the horizontal direction as viewed in FIG. 10), at least one of the light bundles La and Lb cannot be precisely guide to the corresponding line sensor in accordance with the design thereof. Furthermore, the space between the incident points of the light bundles La and Lb upon the pair of line sensors varies if the pair of line sensors are moved forwardly or rearwardly in the direction normal to the light receiving surfaces thereof. Therefore, it is difficult to adjust the incident position of each of the light bundles La and Lb upon the corresponding line sensor by merely moving the line sensor forwardly or rearwardly in the direction normal to the light receiving surfaces thereof.

### SUMMARY OF THE INVENTION

The present invention has been devised in view of the aforementioned problems, wherein an object of the present invention is to provide a multipoint focus detecting apparatus which has a structure that reduces mechanical and assembling errors and that makes it easy to adjust the incident position of each of the light bundles upon the corresponding line sensor even if the incident position deviates from the original position.

To achieve the object mentioned above, according to an aspect of the present invention, a multipoint focus detecting apparatus of a camera is provided, including a plurality of exit-pupil dividing devices for dividing an exit pupil of a photographing lens into a plurality of detection sub-zones in a first direction; a plurality of pairs of light distribution forming devices, each of the pairs of light distribution forming devices receiving light bundles which are passed through a corresponding pair of the plurality of detection sub-zones to form a corresponding pair of light distributions, respectively, relative positions of which varying in accordance with a focusing state of the photographing lens; a plurality of arrays of light receiving elements arranged in a second direction orthogonal to the first direction, the corresponding pair of light distributions being formed on corresponding one array of the plurality of arrays of light receiving elements; a focus detection zone determining device which includes a plurality of focus detection apertures and is positioned in a plane located substantially at a position optically equivalent with a focal plane of the photographing lens, at least two light bundles which are respectively passed through corresponding at least two of the plurality of focus detection apertures being respectively incident on corresponding at least one of the plurality of exit-pupil dividing devices; and at least one deflecting device which deflects light bundles which are respectively passed through the plurality of pairs of light distribution forming devices so that a principal ray of each of the light bundles which are respectively passed through the plurality of pairs of light distribution forming devices is incident on a corresponding one of the plurality of arrays of light receiving elements in a direction normal to a light receiving surface of the corresponding one of the plurality of arrays of light receiving elements, the at least one deflecting device being positioned between the plurality of pairs of light distribution forming devices and the plurality of arrays of light receiving elements.

Preferably, the at least one deflecting device deflects the at least one of the plurality of light bundles which are respectively passed through the plurality of pairs of light distribution forming devices so that the principal rays of the plurality of light bundles which are respectively passed through the plurality of pairs of light distribution forming devices extend parallel to one another in a plane which extends in a direction perpendicular to a direction of alignment of light receiving elements of each of the plurality of arrays of light receiving elements.

Preferably, each pair of the plurality of pairs of light distribution forming devices includes a pair of separator lenses, and wherein the at least one deflecting device includes an auxiliary lens which is symmetrical with respect to a plane which lies parallel to, and extends along the center between, each plane defined by the optical axes of each of two pairs of separator lenses which are provided adjacent in a direction perpendicular to the direction of alignment of the light receiving elements.

In an embodiment, the auxiliary lens is a toric lens wherein an incident or exit surface of which is formed as a toric surface, and wherein a curvature of the toric surface in the first direction is different from a curvature in the second direction orthogonal to the first direction. Alternatively, the anamorphic lens can be a cylindrical lens having optical power only in the second direction.

In an embodiment, the at least one deflecting device includes a prism.

Preferably, each pair of the plurality of pairs of light distribution forming devices is a pair of separator lenses.

Preferably, at least one condenser lens is further provided, positioned between the focus detection zone determining device and the plurality of exit-pupil dividing devices so that the light bundles which are respectively passed through the plurality of focus detection apertures pass through the at least one condenser lens.

Preferably, each of the plurality of exit-pupil dividing devices is a separator mask having at least two apertures. Preferably, each of the plurality of arrays of light receiving elements is a CDD line sensor. Furthermore, the multipoint focus detecting apparatus can be incorporated in an SLR camera.

In an embodiment, the light receiving surface of the gplurality of arrays of light receiving elements can be provided on a common plane.

According to another aspect of the present invention, a multipoint focus detecting apparatus of a camera, is provided, including a separator mask having at least one pair of openings for dividing an exit pupil, of a photographing lens into a plurality of detection sub-zones in a first direction; at least one pair of separator lenses arranged to correspond to the at least one pair of openings, wherein each of the at least one pair of separator lenses receive light bundles which are passed through corresponding one of the at least one pair of openings to form a corresponding pair of light distributions, respectively, relative positions of which vary in accordance with a focusing state of the photographing lens; a plurality of line sensors arranged in a second direction orthogonal to the first direction, the corresponding pair of light distributions being formed on corresponding one of the plurality of line sensors; a field mask which includes a plurality of focus detection apertures and is positioned in a plane located substantially at a position optically equivalent with a focal plane of the photographing lens, at least two light bundles which are respectively passed through corresponding at least two of the plurality of focus detection apertures being respectively incident on corresponding at least one pair of openings; and at least one optical element which deflects light bundles which are passed through the at least one pair of separator lenses so that a principal ray of each of the light bundles which are passed through the at least one pair of separator lenses is incident on corresponding one of the plurality of line sensors in a direction normal to a light receiving surface of the corresponding one of the plurality of line sensors, the at least one optical element being positioned between the at least one pair of separator lenses and the plurality of line sensors.

Preferably, the at least one optical element is symmetrical with respect to a plane which lies along a plane defined by the optical axes of the at least one pair of separator lenses.

The present disclosure relates to subject matter contained in Japanese Patent Application No. 2000-8770 (filed on Jan. 18, 2000) which is expressly incorporated herein by reference in its entirety.

### BRIEF DESCRIPTION OF THE DRAWINGS

The present invention will be described below in detail with reference to the accompanying drawings, in which:

FIG. 1 is a block diagram of fundamental components of a single lens reflex camera provided with a multipoint focus detecting apparatus to which the present invention is applied;

FIG. 2 is a perspective view of an embodiment of an optical system of the multipoint focus detecting apparatus, showing fundamental elements thereof;

FIG. 3 is a schematic side elevational view of the first embodiment of fundamental optical elements of the multipoint focus detecting apparatus, showing optical paths thereof, looking in the direction of the arrow “A” shown in FIG. 2;

FIG. 4 is a view similar to that of FIG. 3, illustrating the second embodiment of fundamental optical elements of the multipoint focus detecting apparatus, showing optical paths thereof;

FIG. 5 is a view similar to that of FIG. 3 illustrating the third embodiment of fundamental optical elements of the multipoint focus detecting apparatus, showing optical paths thereof;

FIG. 6 is a view similar to that of FIG. 3 illustrating the fourth embodiment of fundamental optical elements of the multipoint focus detecting apparatus, showing optical paths thereof;

FIG. 7 is a view similar to that of FIG. 3 illustrating the fifth embodiment of fundamental optical elements of the multipoint focus detecting apparatus, showing optical paths thereof;

FIG. 8 is a view similar to that of FIG. 3 illustrating the sixth embodiment of fundamental optical elements of the multipoint focus detecting apparatus, showing optical paths thereof;

FIG. 9 is a schematic perspective view of fundamental optical elements of a three-point focus detecting apparatus which is structured according to the second or fifth embodiment of the fundamental optical elements of the multipoint focus detecting apparatus; and

FIG. 10 is a schematic side elevational view of fundamental optical elements of a conventional multipoint focus detecting apparatus, showing optical paths thereof for the purpose of explaining the problems that reside in the conventional multipoint focus detecting apparatus.

### DESCRIPTION OF THE PREFERRED EMBODIMENTS

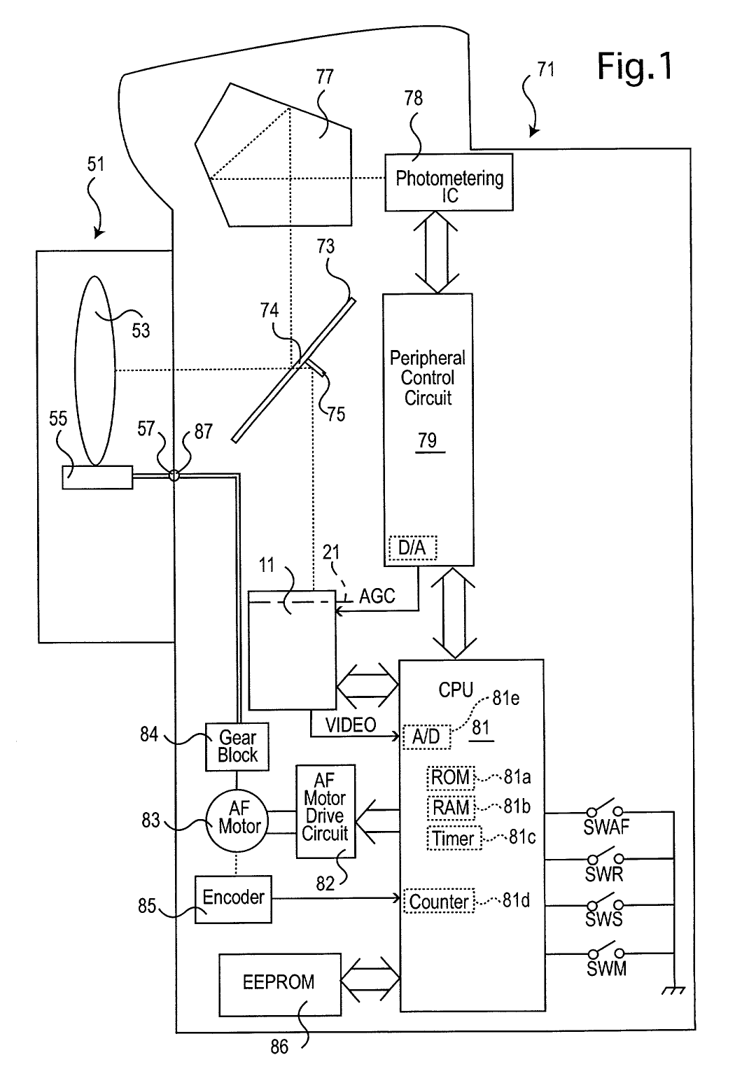

FIG. 1 shows a block diagram of fundamental elements of an SLR (single-lens-reflex) camera system provided with a multipoint focus detecting apparatus to which the present invention is applied. The autofocus SLR camera system includes a camera body 71 and an interchangeable photographing lens 51 detachably attached to the camera body 71. The camera body 71 is provided with a multipoint focus detecting apparatus and an autofocusing device (multipoint autofocusing system) which moves a focusing lens group 53 of the photographing lens 51 to an in-focus position in accordance with the result of detection of the multipoint focus detecting apparatus.

A major part of object light (light which is to form an object image to be photographed) entering the camera body 71 through the photographing lens 51 is reflected by a main mirror (quick-return mirror) 73 toward a pentagonal prism 77, which is a fundamental element of a finder optical system in the camera body 71. Subsequently, the object light is reflected more than once by the pentagonal prism 77 and emerges out of an eyepiece (not shown) positioned behind the pentagonal prism 77. Part of the light reflected by the pentagonal prism 77 enters a light-receiving element of a photometering IC 78. Part of the object light which is incident on the main mirror 73 passes through a half mirror portion 74 provided on the main mirror 73 to be reflected downwardly by an auxiliary mirror 75 provided at the rear of the main mirror 73. The light reflected downwardly by the auxiliary mirror 75 enters a multipoint AF sensor unit 11 that is provided as a multipoint focus detecting apparatus. The multipoint AF sensor unit 11 can determine a focus state (defocus) at each of a plurality of detection zones which are determined by a corresponding plurality of focus detection apertures (slots) formed on a field mask. The multipoint AF sensor unit 11 can be, for example, a phase-difference distance measuring sensor which is provided with a plurality of line sensors (a plurality of arrays of light receiving elements) which respectively correspond to the plurality of detection zones.

The camera body 71 is provided with a main CPU 81 that manages the overall operations of the camera body 71. The output (integral data) of the multipoint AF sensor unit 11 is input to the main CPU 81. The multipoint AF sensor unit 11, a peripheral control circuit 79 to which the photometering IC 78 is connected, an AF motor drive circuit 82 for driving an AF motor 83, an encoder 85, and an EEPROM 86 are provided within the camera body 71 and are all connected to the main CPU 81. The main CPU 81 calculates a defocus amount for each of the plurality of line sensors in accordance with a predetermined operation, using integral data of each of the plurality of line sensors that are input from the multipoint AF sensor unit 11. Subsequently, the main CPU 81 determines the defocus amount to be used, and the priority thereof, in accordance with all the calculated defocus amounts, to determine and calculate the rotational direction and the number of revolutions of the AF motor 83 (i.e., the number of pulses to be output from the encoder 85), respectively. Thereafter, the main CPU 81 drives the AF motor 83 via the AF motor drive circuit 82 in accordance with the determined rotational direction and the calculated number of revolutions. The main CPU 81 detects and counts the pulses output from the encoder 85 in association with the rotation of the AF motor 83. When the counted number of pulses reaches the calculated number of pulses, the main CPU 81 sends a signal to the AF motor drive circuit 82 to stop the AF motor 83.

Rotation of the AF motor 83 is transmitted to the photographing lens 51 through a gear block 84 and a connection between a joint 87 provided on a mount of the camera body 71 and another joint 57 provided on a corresponding mount of the photographing lens 51. The photographing lens 51 is provided therein with a lens drive mechanism 55 for transmitting the rotation of the joint 57 to the focusing lens group 53, so that the focusing lens group 53 is driven by the AF motor 83 via the gear block 84, the joints 87 and 57, and the lens drive mechanism 55.

The main CPU 81 is provided therein with a ROM 81a in which predetermined programs are stored, a RAM 81b in which data for the calculating operation and control operation is temporarily stored, a counting reference timer 81c, a counter 81d, and an A/D converter 81e. The main CPU 81 controls the peripheral control circuit 79 to start operating to calculate an optimum combination of a shutter speed and an aperture value in accordance with photometry data input from the photometering IC 78. Subsequently, the main CPU 81 actuates a focal plane shutter (not shown) provided in the camera body 71 and an iris diaphragm (not shown) provided in the photographing lens 51 via the peripheral control circuit 79. Thereafter, upon the completion of an exposure, the main CPU 81 controls a film motor (not shown) to wind the film by one frame. The EEPROM 86 serving as an external memory is connected to the main CPU 81. The EEPROM 86 stores therein various inherent constants of the camera body 71 and predetermined values necessary for integration control.

A photometering switch SWS which is turned ON when a release button (not shown) is depressed by a half step, and a release switch SWR which is turned ON when the release button is fully depressed, are connected to the main CPU 81. ON/OFF data of each of the photometering switch SWS and the release switch SWR is input to the main CPU 81 so that the main CPU 81 performs predetermined operations in accordance with the ON state of each of the photometering switch SWS and the release switch SWR.

The photographing lens 51 is provided therein with the lens drive mechanism 55 for moving the focusing lens group 53 along the optical axis thereof, and the joint 57 which can be connected to the joint 87 of the camera body 71 to transmit the rotation of the AF motor 83 to the lens drive mechanism 55. The photographing lens 51 is further provided with a ROM (not shown) which stores therein various inherent constants of the photographing lens 51, or a lens CPU (not shown) for calculating variable lens information. The ROM or the CPU of the photographing lens 51 exchanges necessary data or commands with the main CPU 81 when the photographing lens 51 is connected to the camera body 71.

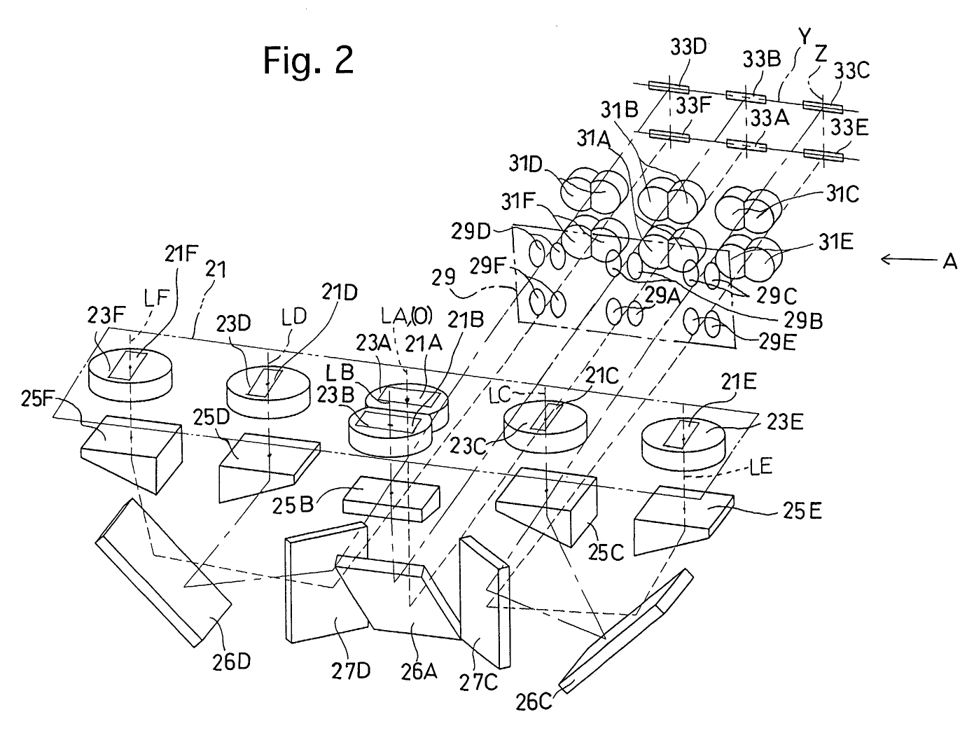

The structure of the multipoint AF sensor unit 11 will be hereinafter discussed in detail with reference to FIG. 2. FIG. 2 is a perspective view of an embodiment of an optical system of the multipoint AF sensor unit 11, showing fundamental elements thereof. The multipoint AF sensor unit 11 is provided with six CCD line sensors 33A, 33B, 33C, 33D, 33E and 33F which correspond to six focus detection zones, respectively. The six focus detection zones are determined by six focus detection slots (focus detection apertures) 21A, 21B, 21C, 21D, 21E and 21F formed on a field mask (focus detection zone determining device) 21 (see FIG. 2) in a predetermined pattern, respectively.

The field mask 21 is disposed in a plane located at a position optically equivalent with a film surface (i.e., a focal plane of the photographing lens). Six condenser lenses 23A, 23B, 23C, 23D, 23E and 23F are positioned behind the field mask 21 to correspond to the six focus detection slots 21A, 21B, 21C, 21D, 21E and 21F, respectively. Five prisms 25B, 25C, 25D, 25E and 25F for deflecting light paths are positioned behind the condenser lenses 23B, 23C, 23D, 23E and 23F. Five mirrors 26A, 26C, 26D, 27C and 27D are positioned behind the five prisms 25B, 25C, 25D, 25E and 25F.

Firstly, the optical systems for the two light bundles (LA and LB) which are respectively passed through the central and upper central focus detection slots 21A and 21B will be hereinafter discussed. The central and upper central light bundles LA and LB which are passed through the central and upper central focus detection slots 21A and 21B pass through the condenser lenses 23A and 23B to be converged therethrough, respectively. The upper central light bundle LB which is passed through the condenser lens 23B passes through the prism 25B to be deflected thereby in a direction to decrease the distance between the light bundles LA and LB. The central light bundle LA does not pass throughthe prism 25B. The central light bundle LA which is passed through the condenser lens 23A is deflected by the central mirror 26A by approximately 90 degrees to proceed towards the line sensor 33A. The prism 25B is positioned behind the condenser lens 23B. The upper central light bundle LB which is passed through the condenser lens 23B and the prism 25B is deflected by the central mirror 26A by approximately 90 degrees to proceed towards the line sensor 33B. In this illustrated embodiment, the primary light ray of the central light bundle LA is coincident with the optical axis 0 of the photographic lens 51.

The multipoint AF sensor unit 11 is provided in front of the six line sensors 33A, 33B, 33C, 33D, 33E and 33F with six pairs of separator lenses (light distribution forming devices) 31A, 31B, 31C, 31D, 31E and 31F, respectively. The multipoint AF sensor unit 11 is further provided in front of the six pairs of separator lenses 31A, 31B, 31C, 31D, 31E and 31F with a separator mask 29. The separator mask 29 is provided thereon with six pairs of openings 29A, 29B, 29C, 29D, 29E and 29F which face the six pairs of separator lenses 31A, 31B, 31C, 31D, 31E and 31F, respectively. Each pair of openings (29A, 29B, 29C, 29D, 29E and 29F) serves as an exit-pupil dividing device which determine detection sub-zones. Part of the central light bundle LA reflected by the central mirror 26A passes through and is divided into two light bundles by the pair of openings 29A, and subsequently these two light bundles pass through the pair of separator lenses 31A to be formed as two images on the central line sensor 33A, respectively, with the two images thereon being apart from each other by a space corresponding to the object distance. Likewise, part of the upper central light bundle LB reflected by the central mirror 26A passes through and is divided into two light bundles by the corresponding pair of openings 29B, and subsequently these two light bundles pass through the pair of separator lenses 31B to be formed as two images on the upper central line sensor 33B, respectively, with the two images thereon being apart from each other by a space corresponding to the object distance.

Note that one side from which a light bundle comes toward an optical member is herein referred to as being “in front of the member”, while another side toward which a light bundle goes away from the optical member is herein referred to as being “behind the member”.

The optical systems for the two light bundles (LC and LE) which are respectively passed through the left and leftmost focus detection slots 21C and 21E will be hereinafter discussed. The prism 25C is positioned behind the condenser lens 23C. A left light bundle LC which is passed through the focus detection slot 21C and the condenser lens 23C is deflected by the prism 25C, in a direction away from the central light bundle LA (i.e., in a direction to the right as viewed in FIG. 2), to be incident on the first left mirror 26C. Subsequently, the left light bundle LC is reflected by the first left mirror 26C to be incident on the second left mirror 27C and is reflected thereby to proceed towards the line sensor 33C.

The prism 25E is positioned behind the condenser lens 23E. A leftmost light bundle LE which is passed through the focus detection slot 21E and the condenser lens 23E is deflected by the prism 25E, in a direction to approach the left light bundle LC, to be incident on the first left mirror 26C. Subsequently, the leftmost light bundle LE is reflected by the first left mirror 26C to be incident on the second left mirror 27C and is reflected thereby to proceed towards the line sensor 33E.

Part of the left light bundle LC reflected by the second left mirror 27C passes through and is divided into two light bundles by the pair of openings 29C, and subsequently these two light bundles pass through the pair of separator lenses 31C to be formed as two images on the line sensor 33C, respectively, with the two images thereon being apart from each other by a space corresponding to the object distance. Likewise, part of the leftmost light bundle LE reflected by the second left mirror 27C passes through and is divided into two light bundles by the pair of openings 29E, and subsequently these two light bundles pass through the pair of separator lenses 31E to be formed as two images on the line sensor 33E, respectively, with the two images thereon being apart from each other by a space corresponding to the object distance.

The optical systems for the two light bundles (LD and LF) which are respectively passed through the right and rightmost focus detection slots 21D and 21F will be hereinafter discussed. Note that the optical systems for the two light bundles which are respectively passed through the focus detection slots 21D and 21F and the optical systems for the two light bundles which are respectively passed through the focus detection slots 21C and 21E are arranged in a plane normal to the optical axis and are arranged symmetrically with respect to the optical axis 0, as shown in FIG. 2.

The prism 25D is positioned behind the condenser lens 23D. A right light bundle LD which is passed through the focus detection slot 21D and the condenser lens 23D is deflected by the prism 25D in a direction away from the central light bundle LA (i.e., in a direction to the left as viewed in FIG. 2) to be incident on the first right mirror 26D. Subsequently, the right light bundle LD is reflected by the first right mirror 26D to be incident on the second right mirror 27D and is reflected thereby to proceed towards the line sensor 33D.

The prism 25F is positioned behind the condenser lens 23F. A rightmost light bundle LF which is passed through the focus detection slot 21F and the condenser lens 23F is deflected by the prism 25F in a direction to approach the right light bundle LD to be incident on the first right mirror 26D. Subsequently, the rightmost light bundle LF is reflected by the first right mirror 26D to be incident on the second right mirror 27D and is reflected thereby to proceed towards the line sensor 33F.

Part of the right light bundle LD reflected by the second right mirror 27D passes through and is divided into two light bundles by the pair of openings 29D, and subsequently these two light bundles pass through the pair of separator lenses 31D to be formed as two images on the line sensor 33D, respectively, with the two images thereon being apart from each other by a space corresponding to the object distance. Likewise, part of the rightmost light bundle LF reflected by the second right mirror 27D passes through and is divided into two light bundles by the pair of openings 29F, and subsequently these two light bundles pass through the pair of separator lenses 31F to be formed as two images on the line sensor 33F, respectively, with the two images thereon being apart from each other by a space corresponding to the object distance.

The central line sensor 33A and the upper-central line sensor 33B are arranged parallel to each other and apart from each other by a predetermined distance in the direction (the vertical direction as viewed in FIG. 2) perpendicular to the direction in which the photodiodes of each line sensor are aligned. Likewise, the line sensors 33C and 33E are arranged parallel to each other and apart from each other by a predetermined distance in the direction (the vertical direction as viewed in FIG. 2) perpendicular to the direction in which the photodiodes of each line sensor are aligned. Likewise, the line sensors 33D and 33F are arranged parallel to each other and apart from each other by a predetermined distance in the direction (the vertical direction as viewed in FIG. 2) perpendicular to the direction in which the photodiodes of each line sensor are aligned. The six line sensors 33A through 33F are arranged so that three line sensors (33A, 33E and 33F) are arranged at regular intervals along a lower line while the remaining three line sensors (33B, 33C and 33D) are arranged at the same regular intervals along an upper line positioned above and parallel to the lower line. The light receiving surfaces of the six line sensors 33A through 33F are positioned on a common plane.

Each of the line sensors 33A through 33F includes an array of photodiodes (array of light receiving elements). Each photodiode accumulates (integrates) an electric charge in accordance with the brightness of the object image formed on the photodiode. The accumulated electric charges are read out of the photodiodes by a conventional drive circuit and is converted into a video signal by a signal processing circuit. This video signal is input to the CPU 81. The CPU 81 determines the distance (phase difference) between a pair of object images formed on each of the line sensors 33A through 33F, using an algorithm according to a phase difference detecting method known in the art. Subsequently, the CPU 81 calculates a defocus amount using the determined distance (phase difference) to determine and calculate the rotational direction and the number of revolutions of the AF motor 39 (i.e., the number of pulses to be output from an encoder 85) necessary for moving the AF lens group 53 to an in-focus position thereof. Note that, in general, the number of pulses to be output from the encoder 85 is calculated using one amount of defocus selected from among the six amounts of defocus obtained for the six line sensors 33A through 33F.

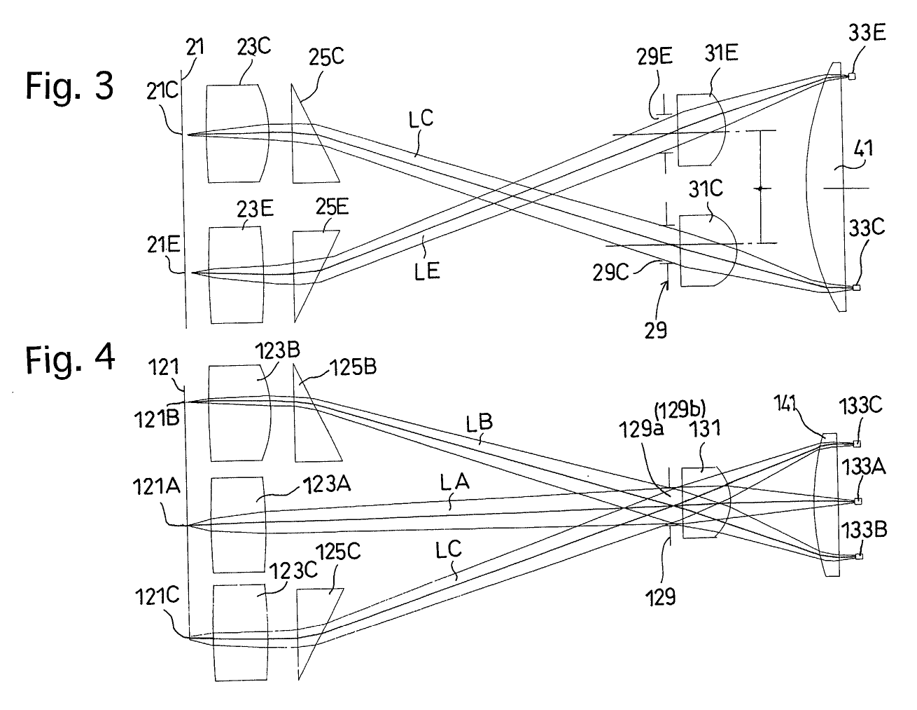

The basic structure of an embodiment of the multipoint AF sensor unit 11 to which the present invention is applied has been discussed above. FIG. 3 is a schematic side elevational view of the first embodiment of fundamental optical elements of the multipoint AF sensor unit 11, showing optical paths thereof, looking in the direction of the arrow “A” shown in FIG. 2 (the mirrors 26A, 26C, 26D, 27C and 27D are not shown for clarity). In this embodiment, in order to make the principal ray of each light bundle which is passed through the corresponding pair of separator lenses incident on the corresponding line sensor in a direction normal to the light receiving surface thereof, an auxiliary lens 41 serving as a deflecting device is disposed between each two pairs of separator lenses and the corresponding two line sensors. Namely, although only one is shown in FIG. 3, three auxiliary lenses 41 are disposed between the two pairs of separator lenses 31A and 31B and the two line sensors 33A and 33B, between the two pairs of separator lenses 31C and 31E and the two line sensors 33C and 33E, and between the two pairs of separator lenses 31D and 31F and the two line sensors 33D and 33F, respectively. In the first embodiment shown in FIG. 3 in which the auxiliary lens 41 is used as a deflecting device, although only the optical elements for the left light bundle LC and the leftmost light bundle LE are shown in FIG. 3, the optical elements for the other light bundles (LD and LF, and LA and LB) are structured in a manner similar to those for the light bundles LC and LE.

In the first embodiment shown in FIG. 3 in which the auxiliary lens 41 is used as a deflecting device, the left light bundle LC, which is passed through the focus detection slot 21C of the field mask 21 that is positioned in a plane located at a position optically equivalent with a film surface, is converged through the condenser lens 23C, which is positioned behind the focus detection slot 21C. At the same time, the leftmost light bundle LE, which is passed through the focus detection slot 21E of the field mask 21, is converged through the condenser lens 23E, which is positioned behind the focus detection slot 21E. Subsequently, the light bundles LC and LE are respectively deflected by the prisms 25C and 25E in directions to approach each other to pass through the two pairs of openings 29C and 29E after intersecting each other, respectively. One of the pair of openings 29C is not shown in FIG. 3, and one of the pair of separator lenses 31C is also not shown in FIG. 3. The pair of openings 29C lie in a line which extends in a direction normal to the page of the drawing in FIG. 3. The pair of separator lenses 31C also lie in a line which extends in a direction normal to the page of the drawing in FIG. 3 to correspond to the pair of separator lenses 31C. Likewise, one of the pair of openings 29E is not shown in FIG. 3, and one of the pair of separator lenses 31E is also not shown in FIG. 3. The pair of openings 29E lie in a line which extends in a direction normal to the page of the drawing in FIG. 3. The pair of separator lenses 31E also lie in a line which extends in a direction normal to the page of the drawing in FIG. 3 to correspond to the pair of separator lenses 31E. Therefore, the light bundle LC is divided into two by the pair of openings 29C of the separator mask 29 to be projected onto the corresponding. line sensor 33C through the pair of separator lenses 31C, so that a pair of object images (a pair of light distributions) are formed on the line sensor 33C. Likewise, the light bundle LE is divided into two by the pair of openings 29E of the separator mask 29 to be projected onto the corresponding line sensor 33E through the pair of separator lenses 31E, so that a pair of object images (a pair of light distributions) are formed on the line sensor 33E. Namely, the object image formed within each of the left and leftmost focus detection slots 21C and 21E is divided into two to be formed as two images on the corresponding line sensor 33C or 33E.

In the first embodiment shown in FIG. 3, the single auxiliary lens 41 serving as a deflecting device is disposed between the separator lenses 31C and 31E and the line sensors 33C and 33E. Each of the light bundles LC and LE which are respectively passed through the pairs of separator lenses 31C and 31E is deflected by the auxiliary lens 41 so that the principal ray of each of the light bundles LC and LE is incident on the corresponding line sensor 33C or 33E in a direction normal to the light receiving surface thereof.

According to the first embodiment shown in FIG. 3 in which the auxiliary lens 41 serving as a deflecting device is used, the incident position of each of the light bundles LC and LE upon the corresponding line sensor 33C or 33E can be easily adjusted by moving the line sensor 33C or 33E, since the principal ray of each of the light bundle LC and LE which are respectively passed through the pairs of separator lenses 31C and 31E is incident on the corresponding line sensor 33C or 33E in a direction normal to the light receiving surface thereof. Furthermore, a plurality of light bundles (i.e., the light bundles LC and LE) are deflected by the single auxiliary lens 41, which does not increase the number of elements of the multipoint AF sensor unit 11 very much.

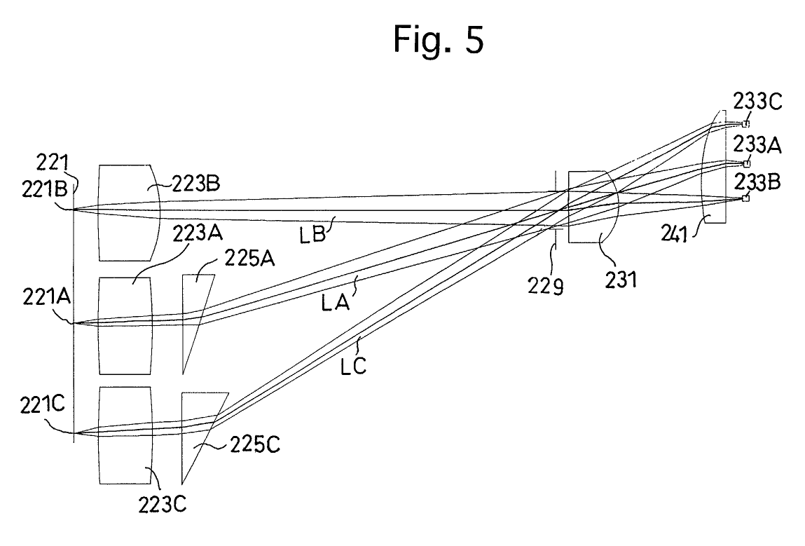

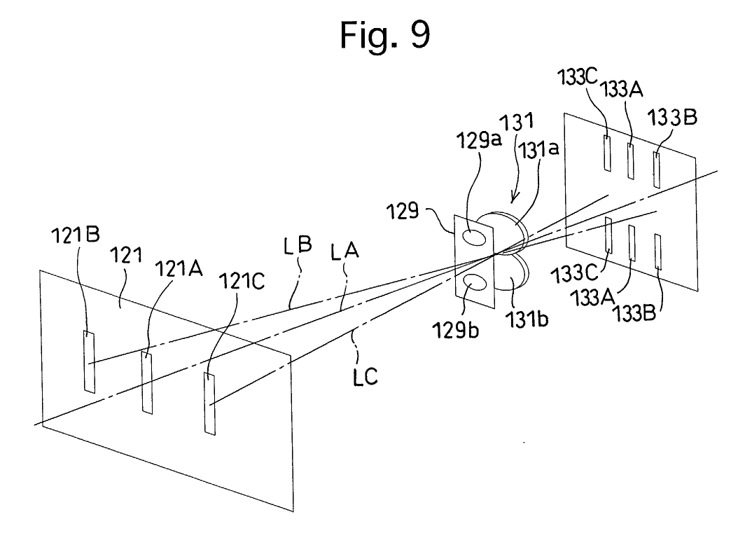

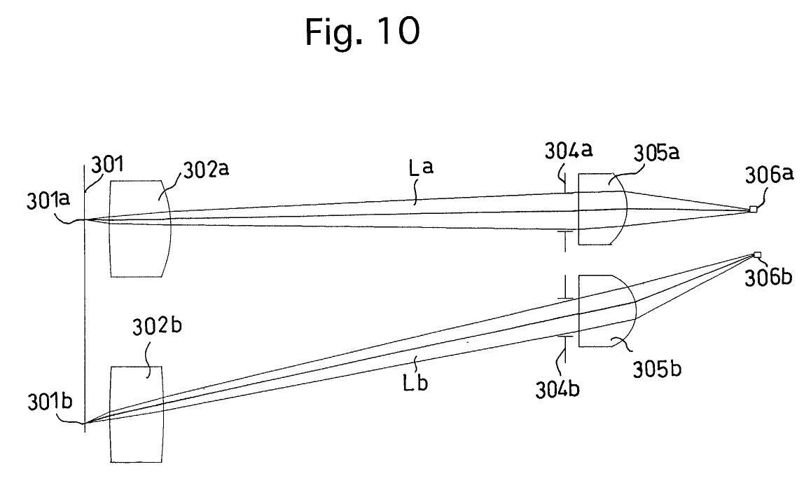

FIG. 4 shows the second embodiment of fundamental optical elements of the multipoint AF sensor unit 11. FIG. 9 is a schematic perspective view of fundamental optical elements of a three-point focus detecting apparatus which is structured according to the second embodiment (or the fifth embodiment which will be discussed later) of the fundamental optical elements of the multipoint AF sensor unit 11 shown in FIG. 4. In this embodiment, the three light bundles LA, LB and LC, which are passed through three focus detection slots (focus detection apertures) 121A, 121B and 121C formed on a field mask (focus detection zone determining device) 121 that is positioned in a plane located at a position optically equivalent with a film surface, are made to pass through a single pair of openings (i.e., an exit-pupil dividing device which determines detection sub-zones) 129a and 129b formed on a separator mask 129 to be each divided into two thereby, and are converged by a pair of separator lenses (light distribution forming devices) 131 (131a and 131b), so that a pair of object images (a pair of light distributions) of each of the three light bundles LA, LB and LC are formed on the corresponding one of three line sensor 133A, 133B and 133C. The separator mask 129 is disposed perpendicular to the optical axis of a condenser lens 123A so as to face the focus detection slot 121A. In the second embodiment shown in FIG. 4, each of the light bundles LA, LB and LC which are passed through the pair of separator lenses 131 (131a and 131b) is deflected by a single auxiliary lens 141 so that the principal ray of each of the light bundles LA, LB and LC is incident on the corresponding line sensor 133A, 133B or 133C in a direction normal to the light receiving surface thereof.

In the second embodiment shown in FIG. 4 in which the auxiliary lens 141 is used as a deflecting device, the light bundle LB, which travels on one side (the upper side as viewed in FIG. 4) of the central light bundle LA and which is passed through the focus detection slot 121B of the field mask 121, is converged through a condenser lens 123B, which is positioned behind the focus detection slot 121B. At the same time, the light bundle LC, which travels on the opposite side (the lower side as viewed in FIG. 4) of the central light bundle LA from the light bundle LB and which is passed through the focus detection slot 121C of the field mask 121, is converged through a condenser lens 123C, which is positioned behind the focus detection slot 121C. Subsequently, among the three light bundles LA, LB and LC which are passed through the three focus detection slots 121A, 121B and 121C to pass through three condenser lenses 123A, 123B and 123C, respectively, the light bundles LB and LC are deflected by prisms 125B and 125C positioned behind the condenser lenses 123B and 123C in directions to approach each other so that all the light bundles LA, LB and LC intersect one another in the vicinity of the separator mask 129 to pass through the separator mask 129. No prism similar to the 125B or 125C is disposed between the condenser lens 123A and the separator mask 129.

A pair of object images (a pair of light distributions) of each of the three light bundles LA, LB and LC which are each divided into two through the separator mask 129 are led to the corresponding line sensor 133A, 133B or 133C via the pair of separator lenses 131. The auxiliary lens 141 which serves as a deflecting device is positioned between the pair of separator lenses 131 and the three line sensors 133A, 133B and 133C. The auxiliary lens 141 deflects the light bundles LA, LB and LC so that the principal ray of each of the light bundles LA, LB and LC each of which has been divided into two by the separator mask 129 and converged by the pair of separator lenses 131 is incident on the corresponding line sensor 133A, 133B or 133C in a direction normal to the light receiving surface of the corresponding line sensor 133A, 133B or 133C.

According to this structure, the incident position of each of the light bundles LA, LB and LC upon the corresponding line sensor 133A, 133B or 133C can be easily adjusted by moving the corresponding line sensor 133A, 133B or 133C since the principal ray of each of the light bundle LA, LB and LC which are passed through the pair of separator lenses 131 is incident on the corresponding line sensor 133A, 133B or 133C in adirection normal to the light receiving surface thereof. Furthermore, a plurality of light bundles (i.e., the light bundles LA, LB and LC) are deflected by the single auxiliary lens 141, which does not increase the number of elements of the multipoint AF sensor unit 11 very much.

FIG. 5 shows the third embodiment of fundamental optical elements of the multipoint AF sensor unit 11. In this embodiment, an auxiliary lens 241 which serves as a deflecting device is used, while three line sensors 233A, 233B and 233C are shifted in a direction parallel to the light receiving surfaces thereof relative to a separator mask 229.

The three light bundles LA, LB and LC, which are passed through three focus detection slots (focus detection apertures) 221A, 221B and 221C formed on a field mask (focus detection zone determining device) 221 that is positioned in a plane located at a position optically equivalent with a film surface, are made to pass through a single pair of openings (i.e., an exit-pupil dividing device which determines detection sub-zones) formed on a separator mask 229 to be each divided into two thereby, and are converged by a pair of separator lenses (light distribution forming devices) 231, so that a pair of object images (a pair of light distributions) of each of the three light bundles LA, LB and LC are formed on the corresponding one of three line sensor 233A, 233B and 233C. One of the pair of openings of the separator mask 229 is not shown in FIG. 5, and one of the pair of separator lenses 231 is also not shown in FIG. 5.

The light bundles LA, LB and LC which are passed through the focus detection slots 221A, 221B and 221C of the field mask 221 are converged through condenser lenses 223A, 223B and 223C which are positioned behind the focus detection slot 221A, 221B and 221C, respectively. Subsequently, among the three light bundles LA, LB and LC which are passed through the three focus detection slots 221A, 221B and 221C to pass through three condenser lenses 223A, 223B and 223C, respectively, the light bundles LA and LC are deflected by prisms 225A and 225C positioned behind the condenser lenses 223A and 223C in directions so as to approach the light bundle LB which is passed through the condenser lens 223B, so that all the light bundles LA, LB and LC intersect one another in the vicinity of the separator mask 229 to pass through the separator mask 229. No prism similar to the prism 225A or 225C is disposed between the condenser lens 223B and the separator mask 229.

In the third embodiment shown in FIG. 5, each of the light bundles LA, LB and LC which are passed through the pair of separator lenses 231 is deflected by a single auxiliary lens 241 so that the principal ray of each of the light bundles LA, LB and LC is incident on the corresponding line sensor 233A, 233B or 233C in a direction normal to the light receiving surface thereof. A pair of object images (a pair of light distributions) of each of the three light bundles LA, LB and LC which are each divided into two through the separator mask 229 are led to the corresponding line sensor 233A, 233B or 233C via the pair of separator lenses 231. The auxiliary lens 241 which serves as a deflecting device is positioned between the pair of separator lenses 231 and the three line sensors 233A, 233B and 233C. The auxiliary lens 241 deflects the light bundles LA, LB and LC so that the principal ray of each of the light bundles LA, LB and LC, each of which has been divided into two by the separator mask 229 and converged by the pair of separator lenses 231, is incident on the corresponding line sensor 233A, 233B or 233C in a direction normal to the light receiving surface of the corresponding line sensor 233A, 233B or 233C.

According to this structure, the incident position of each of the light bundles LA, LB and LC upon the corresponding line sensor 233A, 233B or 233C can be easily adjusted by moving the corresponding line sensor 233A, 233B or 233C since the principal ray of each of the light bundle LA, LB and LC, which are passed through the pair of separator lenses 231, is incident on the corresponding line sensor 233A, 233B or 233C in a direction normal to the light receiving surface thereof. Furthermore, a plurality of light bundles (i.e., the light bundles LA, LB and LC) are deflected by the single auxiliary lens 241, which does not increase the number of elements of the multipoint AF sensor unit 11 very much.

The structure of each of the auxiliary lenses 41, 141 and 241 in the illustrated first, second and third embodiments will be hereinafter discussed.

The auxiliary lens 41 is symmetrical with respect to a reference plane which lies parallel to a first plane defined by the optical axes of the pair of separator lenses 31C and parallel to a second plane defined by the optical axes of the pair of separator lenses 31E and extends along the center between the first and second planes. The auxiliary lens 141 is symmetrical with respect to a plane defined by the two optical axes of the pair of separator lenses 131 (131a and 131b).

The auxiliary lens 241 is asymmetrical with respect to a plane equivalent to the aforementioned defined plane which includes the two optical axes of the pair of separator lenses 131.

Each of the auxiliary lenses 41, 141 and 241 is an anamorphic lens whose refractive power in the first direction in which an exit pupil of the photographing lens is divided by each pair of openings of the separator mask is different from the refractive power of the second direction perpendicular to the first direction. The anamorphic lens may be a toric lens whose incident or exit surface is formed as a toric surface. The curvature of this toric surface in the first direction is different from that in the second direction perpendicular to the first direction. Alternatively, the anamorphic lens can be a cylindrical lens having optical power only in the above-mentioned second direction perpendicular to the first direction.

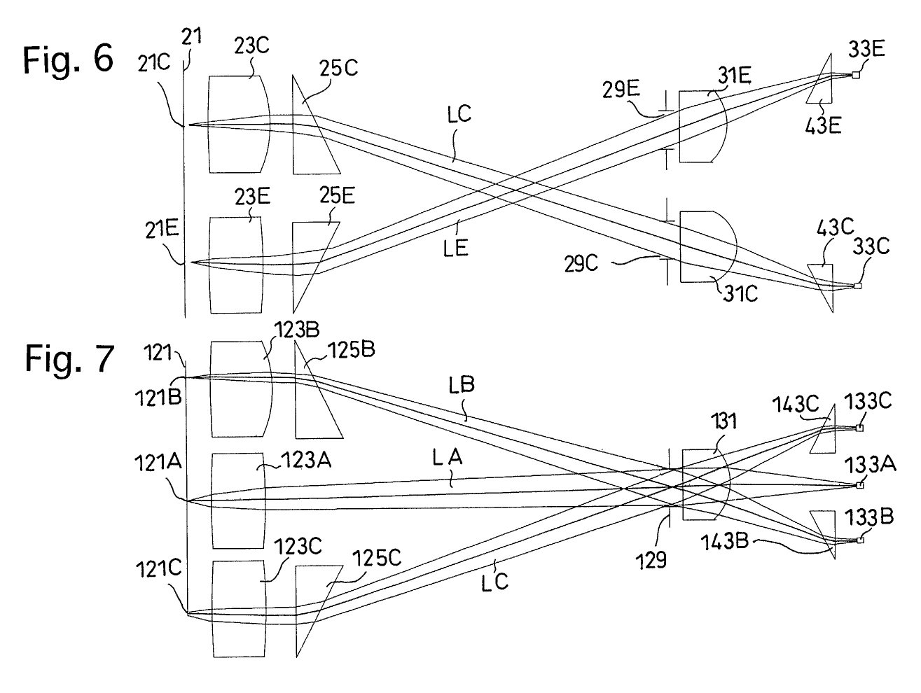

FIG. 6 shows the fourth embodiment of fundamental optical elements of the multipoint AF sensor unit 11. In this embodiment, in order to make the principal ray of each light bundle which is passed through the corresponding pair of separator lenses 31C or 31E incident on the corresponding line sensor 33C or 33E in a direction normal to the light receiving surface thereof, a prism 43C which serves as a deflecting device is positioned between the pair of separator lenses 31C and the corresponding line sensors 33C, while a prism 43E which serves as a deflecting device is positioned between the pair of separator lenses 31E and the corresponding line sensors 33E. The fourth embodiment is the same as the first embodiment shown in FIG. 3 if the prisms 43C and 43E are replaced by the auxiliary lens 41 (shown in FIG. 3) which serves as a deflecting device, so that optical members in the fourth embodiment which are substantially identical to those in the first embodiment shown in FIG. 3 are designated by the same reference numerals.

In the fourth embodiment shown in FIG. 6, the prism 43C and 43E each serving as a deflecting device is disposed between the pairs of separator lenses 31C and 31E and the line sensors 33C and 33E, respectively. The light bundles LC and LE which are passed through the slots (focus detection apertures) 21C and 21E are converged through the condenser lenses 23C and 23E, respectively. Subsequently, the light bundles LC and LE are respectively deflected by the prisms 25C and 25E in directions to approach each other to pass through the two pairs of openings 29C and 29E after intersecting each other, respectively. Each of the light bundles LC and LE which are respectively passed through the pairs of separator lenses 31C and 31E is deflected by the corresponding prism 43C or 43E so that the principal ray of each of the light bundles LC and LE is incident on the corresponding line sensor 33C or 33E in a direction normal to the light receiving surface thereof.

According to the fourth embodiment shown in FIG. 6 in which the prisms 43C and 43E each serving as a deflecting device are used, the incident position of each of the light bundles LC and LE upon the corresponding line sensor 33C or 33E can be easily adjusted by moving the line sensor 33C or 33E, since the principal ray of each of the light bundle LC and LE which are respectively passed through the pairs of separator lenses 31C and 31E is incident on the corresponding line sensor 33C or 33E in a direction normal to the light receiving surface thereof. Furthermore, the angle of deflection and/or the direction of deflection of each light bundle which is incident on the corresponding line sensor can be adjusted independently from the other light bundles.

FIG. 7 shows the fifth embodiment of fundamental optical elements of the multipoint AF sensor unit 11. In this embodiment, in order to make the principal ray of each light bundle which is passed through a pair of separator lenses 131 incident on the corresponding line sensor in a direction normal to the light receiving surface thereof, a prism 143C which serves as a deflecting device is positioned between the pair of separator lenses 131 and the corresponding line sensors 133C, while a prism 143B which serves as a deflecting device is positioned between the pair of separator lenses 131 and the corresponding line sensors 133B. The fifth embodiment is the same as the second embodiment shown in FIG. 4 if the prisms 143B and 143C are replaced by the auxiliary lens 141 (shown in FIG. 4) which serves as a deflecting device, so that optical members in the fifth embodiment which are substantially identical to those in the second embodiment shown in FIG. 4 are designated by the same reference numerals.

In the fifth embodiment shown in FIG. 7, the prism 143B is disposed between the pair of separator lenses 131 and the line sensor 133B, while the prism 143C is disposed between the pair of separator lenses 131 and the line sensor 133C. No deflecting device such as a lens or aprism is disposed between the pair of separator lenses 131 and the line sensor 133A. Since the optical path for the central light bundle LA is determined so that the principal ray thereof is incident on the line sensor 133A in a direction normal to the light receiving surface thereof, the prisms 143B and 143C are positioned so that the principal ray of each of the light bundles LB and LC is incident on the corresponding line sensor 133B or 133C in a direction normal to the light receiving surface thereof.

The light bundles LB and LC which are passed through the focus detection slots 121B and 121C are converged through the condenser lenses 123B and 123C, respectively. Subsequently, the light bundles LB and LC are respectively deflected by the prisms 125B and 125C in directions so as to approach each other, so that the light bundles LA, LB and LC all intersect one another in the vicinity of the separator mask 129 to pass through the separator mask 129. The light bundles LA, LB and LC pass through the pair of separator lenses 131 (131a and 131b) after intersecting one another. Each of the incident light bundles LB and LC which are passed through the pair of condenser lenses 131 is deflected by the corresponding prism 143B or 143C so that the principal ray of each of the incident light bundles LB and LC is incident on the corresponding line sensor 133B or 133C in a direction normal to the light receiving surface thereof. Accordingly, each of the light bundles LA, LB and LC is led to the corresponding line sensor 133A, 133B or 133C so that the principal ray of each of the light bundles LA, LB and LC is incident on the corresponding line sensor 133A, 133B or 133C in a direction normal to the light receiving surface thereof, so that a pair of object images (a pair of light distributions) are formed on each of the line sensors 133A, 133B and 133C.

According to the fifth embodiment shown in FIG. 7, the angle of deflection and/or the direction of deflection of each of the light bundles LB and LC can be adjusted by moving the corresponding prism 143B or 143C after the incident position of the light bundle LA upon the line sensor 133A is adjusted. This makes it possible to adjust the angle of deflection and/or the direction of deflection of each of the light bundles LB and LC, which are respectively incident on the line sensors 113B and 113C, independently from the other light bundles.

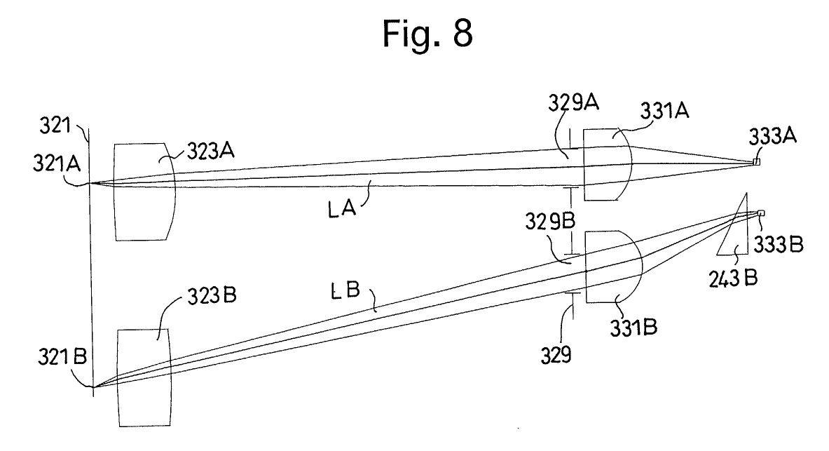

FIG. 8 shows the sixth embodiment of fundamental optical elements of the multipoint AF sensor unit 11. In this embodiment, two light bundles LA and LB which are passed through focus detection slots (focus detection apertures) 321A and 321B formed on a field mask (focus detection zone determining device) 321 are guided so as to be incident on two line sensors 333A and 333B, respectively. The space between the two focus detection slots 321A and 321B is much greater than the space between the two Line sensors 333A and 333B. In order to make the principal ray of each light bundle which is passed through a pair of separator lenses incident on the corresponding line sensor in a direction normal to the light receiving surface thereof, a prism 243B which serves as a deflecting device is positioned between a pair of separator lenses (light distribution forming devices) 331B and the corresponding line sensors 333B. Note that no prism is positioned between a pair of separator lenses (light distribution forming devices) 331A and the corresponding line sensors 333A.

In the sixth embodiment, the light bundle LA which is passed through the focus detection slot 321A is converged by the condenser lens 323A, while the light bundle LB which is passed through the focus detection slot 321B is converged by the condenser lens 323B and deflected by the same in a direction to approach the light bundle LA which is passed through the condenser lens 323A. The light bundles LA and LB which are passed through the condenser lenses 323A and 323B proceed towards a separator mask 329 in directions to approach each other so that each of the light bundles LA and LB passes through a corresponding pair of openings 329A or 329B (i.e., an exit-pupil dividing device which determines detection sub-zones) of the separator mask 329 and the corresponding separator lenses 331A or 331B, so that a pair of object images (a pair of light distributions) are formed on each of the line sensors 333A and 333B.

The optical path for the light bundle LA is designed so that the principal ray thereof is incident on the line sensor 133A in a direction normal to the light receiving surface thereof without using any deflecting device such as the prism 243B. On the other hand, the light bundle LB which is passed through the separator mask 329 is deflected by the pair of separator lenses 331B in a direction to further approach the light bundle LA, and is subsequently deflected by the prism 243B to be incident on the line sensor 333B.

According to the sixth embodiment shown in FIG. 8, even if the space between two adjacent slots (focus detection apertures) among a plurality of slots (focus detection apertures) formed on the field mask is large, the space between a pair of object images (a pair of light distributions) formed on corresponding two line sensors by two light bundles which are passed through the two adjacent slots (focus detection apertures) can be made small. At the same time, the principal ray of each light bundle which is passed through a corresponding pair of separator lenses can be incident on the corresponding line sensor 333A or 333B in a direction normal to the light receiving surface thereof.

As can be seen from the above discussions, according to the multipoint focus detecting apparatus to which the present invention is applied, the principal ray of at least one light bundle which is passed through a corresponding focus detection aperture and is subsequently divided into two, through a corresponding pair of openings formed on a separator mask and a corresponding pair of separator lenses, is deflected by a lens or a prism positioned between the pair of separator lenses and a corresponding line sensor so as to be incident on the line sensor in a direction normal to the light receiving surface thereof, the positional relationship between each pair of object images, which is formed by the corresponding one light bundle that is passed through the corresponding focus detection aperture, and the corresponding line sensor is not susceptible to a mechanical error or assembling error. Furthermore, the incident position of each light bundle on the corresponding line sensor can be easily adjusted even if an error occurs, namely, even if the incident position deviates from the original position.

As can be understood from the foregoing, according to the multipoint focus detecting apparatus to which the present invention is applied, since light receiving surfaces of the plurality of arrays of light receiving elements are provided on a common plane, and at least one deflecting device which deflects light bundles which are respectively passed through the plurality of pairs of light distribution forming devices (separator lenses) so that a principal ray of each of the light bundles which are respectively passed through the plurality of pairs of light distribution forming devices is incident on a corresponding one of the plurality of arrays of light receiving elements in a direction normal to a light receiving surface of the corresponding one of the plurality of arrays of light receiving elements, each light bundle which is passed through the corresponding focus detection aperture can reliably and precisely be made incident on the corresponding line sensor. Furthermore, the alignment of each line sensor and the position of each line sensor in the optical axis direction can be easily adjusted. Since a deflecting device is disposed immediately in front of one or more line sensor, the direction of deflection of each light bundle by the deflecting device can be easily adjusted.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A multipoint focus detecting apparatus of a camera, comprising: a plurality of exit-pupil dividing devices for dividing an exit pupil of a photographing lens into a plurality of detection sub-zones in a first direction;
a plurality of pairs of light distribution forming devices, each of said pairs of light distribution forming devices receiving light bundles which are passed through a corresponding pair of said plurality of detection sub-zones to form a corresponding pair of light distributions, respectively, relative positions of which varying in accordance with a focusing state of said photographing lens;
a plurality of arrays of light receiving elements arranged in a second direction orthogonal to said first direction, said corresponding pair of light distributions being formed on corresponding one array of said plurality of arrays of light receiving elements;
a focus detection zone determining device which comprises a plurality of focus detection apertures and is positioned in a plane located substantially at a position optically equivalent with a focal plane of said photographing lens, at least two light bundles which are respectively passed through corresponding at least two of said plurality of focus detection apertures being respectively incident on corresponding at least one of said plurality of exit-pupil dividing devices; and
at least one deflecting device which deflects light bundles which are respectively passed through said plurality of pairs of light distribution forming devices so that a principal ray of each of said light bundles which are respectively passed through said plurality of pairs of light distribution forming devices is incident on a corresponding one of said plurality of arrays of light receiving elements in a direction normal to a light receiving surface of said corresponding one of said plurality of arrays of light receiving elements, said at least one deflecting device being positioned between said plurality of pairs of light distribution forming devices and said plurality of arrays of light receiving elements.

2. The multipoint focus detecting apparatus according to claim 1, wherein said at least one deflecting device deflects said at least one of said plurality of light bundles which are respectively passed through said plurality of pairs of light distribution forming devices so that said principal rays of said plurality of light bundles which are respectively passed through said plurality of pairs of light distribution forming devices extend parallel to one another in a plane which extends in a direction perpendicular to a direction of alignment of light receiving elements of each of said plurality of arrays of light receiving elements.

3. The multipoint focus detecting apparatus according to claim 1, wherein each pair of said plurality of pairs of light distribution forming devices comprises a pair of separator lenses, and wherein said at least one deflecting device comprises an auxiliary lens which is symmetrical with respect to a plane which lies parallel to, and extends along the center between, each plane defined by the optical axes of each of two pairs of separator lenses which are provided adjacent in a direction perpendicular to the direction of alignment of said light receiving elements.

4. The multipoint focus detecting apparatus according to claim 3, wherein said auxiliary lens is a toric lens wherein an incident or exit surface of which is formed as a toric surface, and wherein a curvature of said toric surface in said first direction is different from a curvature in said second direction orthogonal to said first direction.

5. The multipoint focus detecting apparatus according to claim 3, wherein said auxiliary lens is a cylindrical lens having optical power only in said second direction.

6. The multipoint focus detecting apparatus according to claim 1, wherein said at least one deflecting device comprises a prism.

7. The multipoint focus detecting apparatus according to claim 1, wherein each pair of said plurality of pairs of light distribution forming devices comprises a pair of separator lenses.

8. The multipoint focus detecting apparatus according to claim 1, further comprising at least one condenser lens positioned between said focus detection zone determining device and said plurality of exit-pupil dividing devices so that said light bundles which are respectively passed through said plurality of focus detection apertures pass through said at least one condenser lens.

9. The multipoint focus detecting apparatus according to claim 1, wherein each of said plurality of exit-pupil dividing devices comprises a separator mask having at least two apertures.

10. The multipoint focus detecting apparatus according to claim 1, wherein each of said plurality of arrays of light receiving elements comprises a CDD line sensor.

11. The multipoint focus detecting apparatus according to claim 1, wherein said multipoint focus detecting apparatus is incorporated in an SLR camera.

12. The multipoint focus detecting apparatus according to claim 1,wherein said light receiving surface of said plurality of arrays of light receiving elements are provided on a common plane.

13. A multipoint focus detecting apparatus of a camera, comprising:
a separator mask having at least one pair of openings for dividing an exit pupil of a photographing lens into a plurality of detection sub-zones in a first direction;
at least one pair of separator lenses arranged to correspond to said at least one pair of openings, wherein each of said at least one pair of separator lenses receive light bundles which are passed through corresponding one of said at least one pair of openings to form a corresponding pair of light distributions, respectively, relative positions of which vary in accordance with a focusing state of said photographing lens;
a plurality of line sensors arranged in a second direction orthogonal to said first direction, said corresponding pair of light distributions being formed on corresponding one of said plurality of line sensors;
a field mask which comprises a plurality of focus detection apertures and is positioned in a plane located substantially at a position optically equivalent with a focal plane of said photographing lens, at least two light bundles which are respectively passed through corresponding at least two of said plurality of focus detection apertures being respectively incident on corresponding said at least one pair of openings; and
at least one optical element which deflects light bundles which are passed through said at least one pair of separator lenses so that a principal ray of each of said light bundles which are passed through said at least one pair of separator lenses is incident on corresponding one of said plurality of line sensors in a direction normal to a light receiving surface of said corresponding one of said plurality of line sensors, said at least one optical element being positioned between said at least one pair of separator lenses and said plurality of line sensors.

14. The multipoint focus detecting apparatus according to claim 13, wherein said at least one optical element is symmetrical with respect to a plane which lies along a plane defined by the optical axes of said at least one pair of separator lenses.
